(19) United States
(12) Patent Application Publication
(10) Pub. No.: US 2006/0086078 A1
(43) Pub. Date: Apr. 27, 2006

(54) Universal Carnot propulsion systems for turbo rocketry

(76) Inventor: Marius A. Paul, Fullerton, CA (US)

Correspondence Address: RICHARD ESTY PETERSON;Patent Attorney, 1905-D Palmetto Ave., Pacifica, CA, 94044, US

(21) Appl. No.: 11/254,421

(22) Filed: Oct. 20, 2005

Related U.S. Application Data
(60) Provisional application No. 60/621,183, filed on Oct. 21, 2004.
(60) Provisional application No. 60/646,009, filed on Jan. 21, 2005.

(51) Int. Cl. F02K 3/02

(52) U.S. Cl. 60/226.1

(57) ABSTRACT

Turbofan jet engines utilizing the Carnot cycle for improved performance with isothermal compression of combustion air and, in part, isothermal expansion of thermally heated air, the engines having a turbofan compressor rotor with hollow fan blades in a core bypass passage through the engine and an annular, peripheral thermal chamber with staged turbine blades in an expansion chamber where heated gases are supplied to multiple stages to maintain peak temperatures.

### REFERENCES TO PRIOR APPLICATIONS

This application relies on the priority of the following provisional applications:

U.S. Provisional Application Ser. No. 60/621,183, filed Oct. 21, 2004, entitled UNIVERSAL PROPULSION CARNOT CYCLES TURBO ROCKETRY; and

U.S. Provisional Application Ser. No. 60/646,009, filed Jan. 21, 2005, entitled UNIVERSAL PROPULSION CARNOT CYCLES IN TURBO ROCKETRY.

### BACKGROUND OF THE INVENTION

This invention utilizes a Carnot cycle to improve the performance of aircraft engines and is designed to utilize alternate thermal sources including fuel cells, nuclear power reactors and mixed fuel combustors for combined jet and rocket propulsion permitting extended and indefinite flight of manned and unmanned aircraft.

Actual state-of-the-art conventional aerospace propulsion systems are under many limitations. Reduced gas turbine power density, reduced thrust to weight ratios, reduced thermal efficiency and reduced cycle pressure ratios are a direct result of limited maximum turbine inlet temperature, limited by the metallurgical characteristics of the turbine blades.

Liquid fuel rocket propulsion systems based on liquid oxygen (LOX), are exclusively for space propulsion and are not applicable to the field of military and commercial air aviation because of the enormous cost of operation.

### SUMMARY OF THE INVENTION

The revolutionary universal Carnot propulsion systems for turbo rocketry eliminate many technological barriers which have typically resulted in limited thermal efficiencies averaging 30% with pressure ratios of 25/1, air fuel ratios of 60/1 and thrust to weight ratios of 16/1, which generally use only 25% of the air compressed in the gas turbines.

Our revolutionary Carnot rocket propulsion system opens the capability to combine atmospheric oxygen in high altitude aviation with the addition of supplemental LOX for extended altitude range into space. The most exceptional characteristic of the described propulsion systems is the common option to use fuel combustors, fuel cells and/or nuclear energy reactors in the same propulsion system, separately or in combination.

For all alternatives, the main characteristic is the maximum absolute thermal efficiency of the Carnot thermal cycle, producing the maximum absolute range of flight for the available thermal source. For all alternatives, the final compression process is isothermal, with minimum work for compression and a minimum temperature at the end of the compression. For all alternatives, the combustion process cane achieve a maximum absolute isothermal and stoichiometric level, resulting in maximum power density and the maximum absolute thrust to weight ratio possible.

State-of-the-art gas turbines are not conserving the maximum turbine inlet temperature and pressure ratio of the cycle from full load to part loads, and are thereby losing the temperature and pressure ratios at part loads. The corresponding loss of thermal efficiency results in raising the specific fuel consumption to unacceptable high levels and severely limits the range of flight.

The revolutionary gas turbine Carnot cycle engines of this invention can operate at a constant isothermal temperature resulting in better efficiency and better specific fuel consumption at all loads of operation for extended flight.

### BRIEF DESCRIPTION OF THE DRAWINGS

FIG. 1 is a thermal diagram, illustrating the inefficiencies of the Brayton cycle.

FIG. 2 is a schematic illustration of a turbofan jet engine incorporating a Carnot cycle and a basic turbofan rotor assembly.

FIG. 3 is a perspective view of the basic turbofan rotor assembly of FIG. 2.

FIG. 4 is a perspective view of the rotor assembly of FIG. 2 with a guide shroud removed.

FIG. 5 is a perspective view of the vaned shaft bearing of the rotor assembly of FIG. 2.

FIG. 6 is a perspective view of the fan blade assembly of the rotor assembly of FIG. 2.

FIG. 7 is a perspective view of a hollow blade in the blade assembly of FIG. 6.

FIG. 8 is a schematic illustration of a turbofan jet engine with counter-rotating air fan blades.

FIG. 9 is a schematic illustration of a turbofan jet engine with a modified turbofan compressor rotor.

FIG. 10 is a schematic illustration of an enlarged portion of the turbofan jet engine of FIG. 9.

FIG. 11 is a schematic illustration of a turbofan jet engine with added rocket propulsion.

FIG. 12 is a schematic illustration of a dual nuclear thermal source for the engine of FIG. 11.

FIG. 13 is a schematic illustration of a turbofan jet engine with added rocket propulsion and alternate thermal sources.

FIG. 14 is a schematic illustration of a turbofan jet engine with added rocket propulsion and supplemental liquid oxygen supply.

FIG. 15 is a schematic illustration of a triple thermal cycle turbofan turbojet and air rocket Carnot engine.

FIG. 16 is an enlarged schematic illustration of the central core engine of the triple thermal cycle engine described in FIG. 15.

### DETAILED DESCRIPTION OF THE PREFERRED EMBODIMENTS

The universal Carnot cycle engine of this invention is generally designated by the reference numeral 10. The preferred engine design of this description utilizes a novel isothermal compressor system as described in my referenced application to enable a maximized thermal difference between the compressed air available for thermal heating and the practical temperature limit for combustion as defined by the structural integrity of the turbine blades or blade segments subject to the high temperature of the motive gases after heating. Since the engine 10 of this invention is designed for high altitude flight, the entry temperature of air for compression is low, in the minus range of −50° C. to −100° C., and can be used for isothermal compression of the air not passed through the core of the engine as bypass air. With a maximized delta T or temperature difference available for thermal heating and expansion of the drive gases, multiple thermal sources can be considered in alternatives or in combinations, making for high efficiency, long distance flight. As noted, by injecting liquid oxygen into the air flow passages, aerospace flight can be achieved in any of the engine embodiments described.

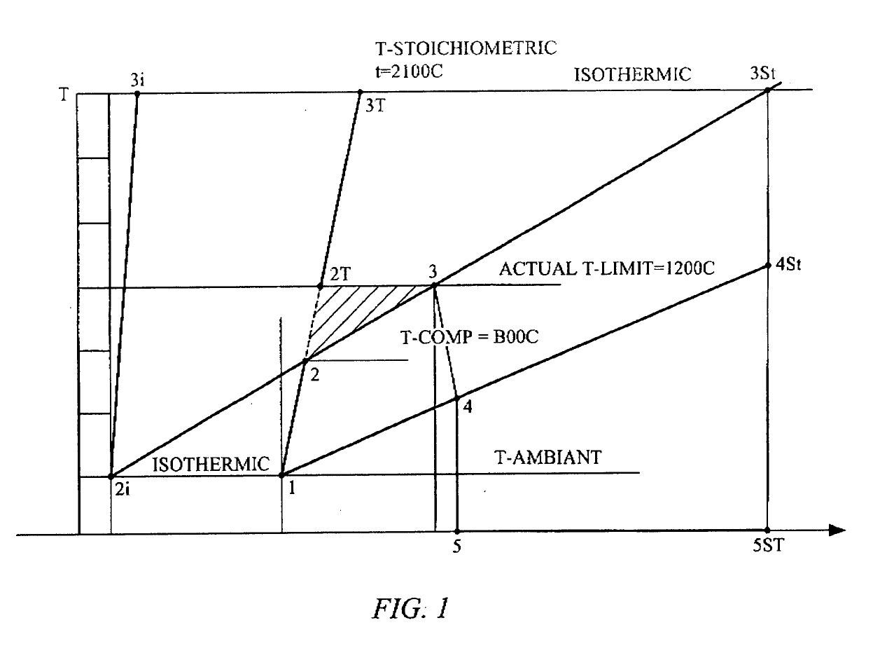

Referring to FIG. 1, a thermal diagram shows the limitations of a Brayton Cycle engine when compared to the improved Carnot systems when applied to gas turbines and turbine-rocket engines for high elevation flight.

The inlet temperature for state-of-the-art gas turbines is typically maximized at 1200° C. The optimum pressure ratio for the maximum inlet temperature of 1200° C. is usually 25/1. This pressure ratio corresponds to a maximum thermal efficiency of 30%. Internal cooling of turbine blades with compressed air which reaches 800° C. permits only a constant pressure combustion developing power in the limited temperature interval of 800°-1200° C. Attempting to raise the pressure ratio for improved efficiency by an increase in the air compression results in a higher temperature of the compressed air which reduces the cooling ability of the compressed air and the temperature differential available for the combustion process with an accompanied loss in power.

At a certain point, a total loss of power will result when the compressed air temperature at the thermal source inlet is raised to the maximum thermal source temperature for the turbine blades. When this occurs, no heat can be added and/or no fuel can be burned and hence, no power can be produced.

In conclusion, with the Brayton Cycle, the thermal efficiency cannot be improved if a higher turbine inlet temperature cannot be achieved.

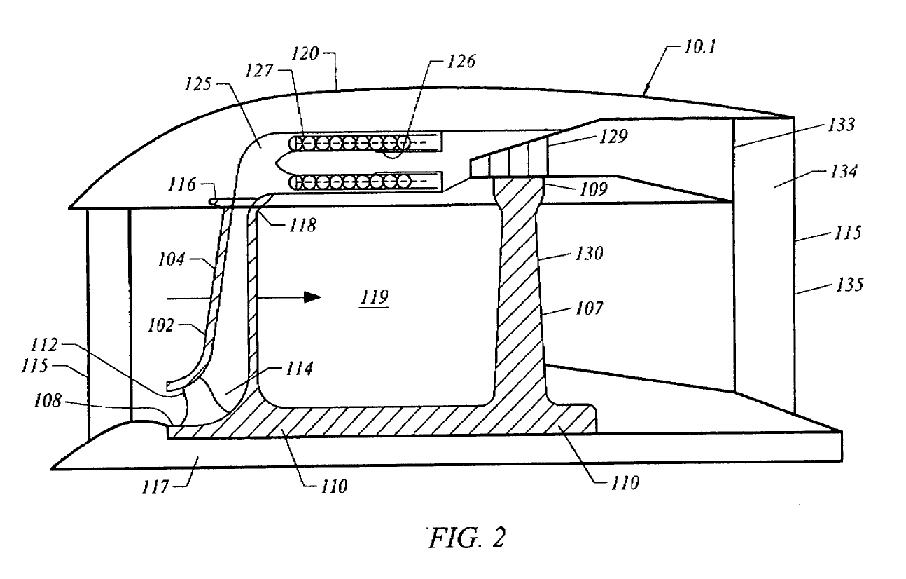

Referring to FIG. 2, the Carnot cycle engine identified generally by the reference numeral 10, has a turbofan compressor rotor 102 of the type described in my earlier applications for centrifugally compressing intake air received into hollow fan blades 104 in an isothermal manner by use of the cold bypass air.

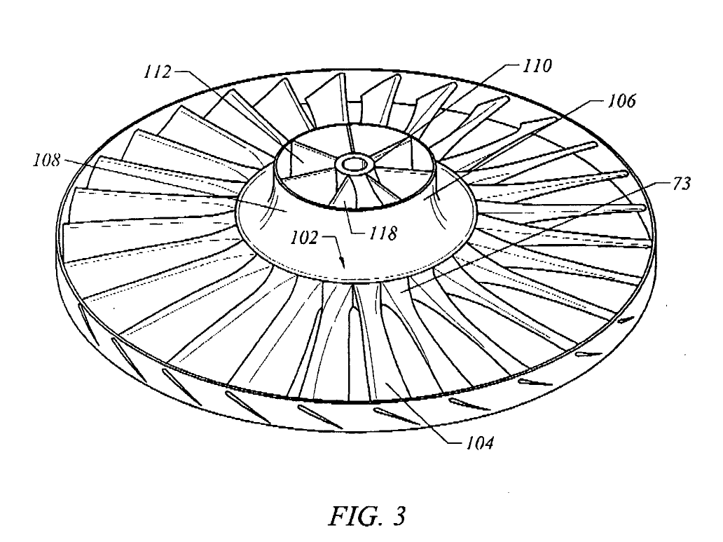

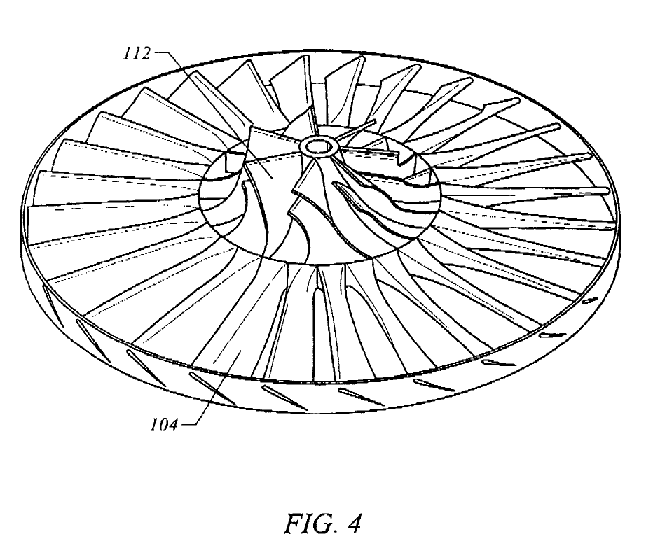

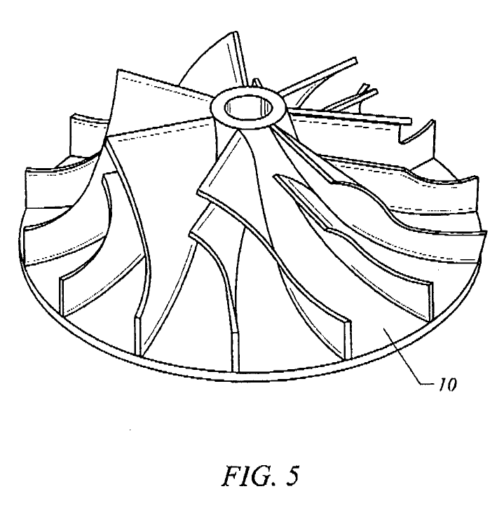

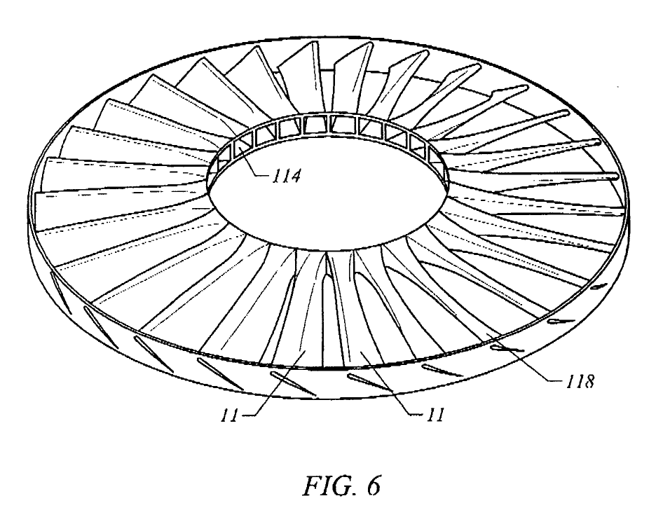

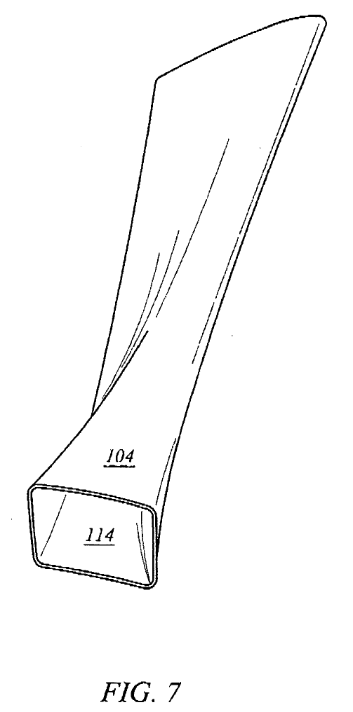

As shown in FIGS. 3-6, the turbofan rotor 102 for the basic engine 10.1 comprises a rotor assembly 106 having an improved construction for maximizing the air intake into the hollow blades 104. The rotor assembly 106 has a hub 108 with a shaft bearing 110 with a series of curved radial vanes 112 inside a curved guide shroud 113 to aid in scooping air into the entry passage 114 of the blades 104 as shown in FIGS. 5 and 6. A peripheral rim 116 interconnects the open end tips 118 of the blades 104 and provides a baffle separating the core bypass passage 119 through the engine 10.1 and an annular peripheral thermal chamber 125 around the rotor 102.

The turbofan jet engine 10.1 of FIG. 2 has a cowling or outer housing 120 with an air intake 107 and with fore and aft struts 115 and center shaft 117. The housing 120 contains the thermal chamber 125, which includes a thermal source 126. The thermal source 126, in one preferred embodiment, comprises a nuclear ball reactor 127. Part of the dense ram air from the air intake is isothermally compressed in hollow fan blades 104 by the remaining cold flow-through air that passes through the core of the engine. The compressed air is radially ejected through blade tip openings into the peripheral thermal chamber 125. The isothermally compressed air is heated by the thermal source 126 and passes into an expansion chamber 128 for staged expansion through the staged turbine blades 129 of a gas turbine fan 130. The gas turbine fan 130 has the same shaft bearing 110 as the rotor assembly hub 108. The shaft bearing 110 carries the redial fan blades 107 and turbine blades 129, which are separated from the fan blades 107 by a rim 109.

The expanding gases from the turbine blades 129 of the gas turbine fan 130 discharge from an annular nozzle 133 to mix with and heat the flow through bypass air in a final combined jet nozzle 134 at the tail end 135 of the housing 120. The gas turbine blades 129 drive the fan blades 107 to accelerate the bypass air for added thrust, and drive the connected turbofan rotor 102. The thermal source 126 may alternately comprise fuel cells or a fuel combustor.

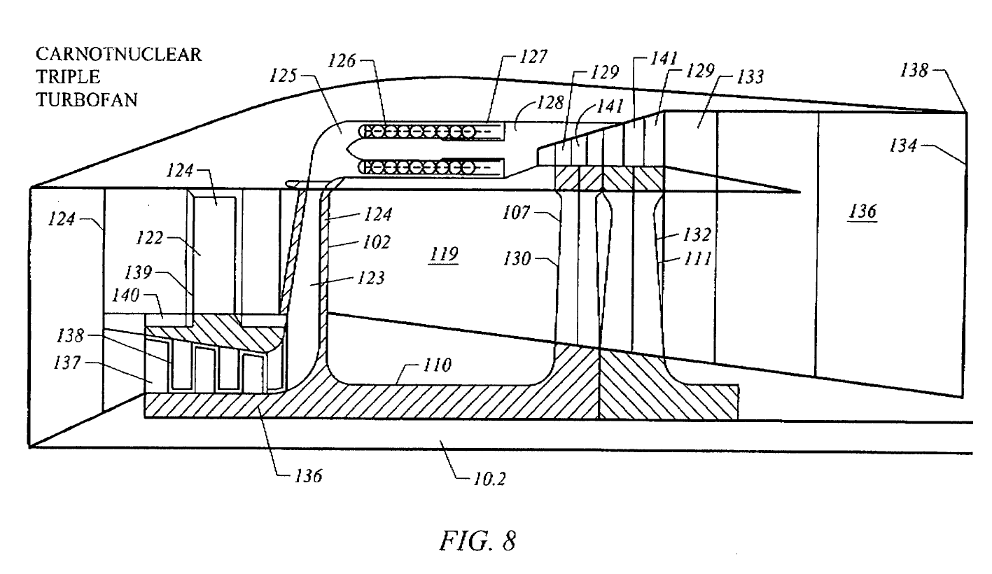

Referring to FIG. 8, the turbofan jet engine 10.2 has a construction similar to that of FIG. 2 with certain components in common. The engine 10.2 replaces the radial vanes 112 of the hub 108 with an axial compressor 136 with staged blades 137 rotating counter to the blades 138 of a free wheeling fan 139 on bearings 140 supported by struts 124. The free wheeling fan 139 is driven by the ram air and has fan blades 122 rotating counter to the turbofan rotor 102 to drive the axial compressor blades 138 for precompressing a portion of the intake ram air before entering the hollow passage 123 of the rotor blades 104.

In addition to the gas turbine fan 130, the engine 10.2 has a second stage gas turbine fan 132 that rotates counter to the gas turbine fan 130 connected to the turbofan rotor 102. The spaced turbine blades 129 of both turbine fans 130 and 132 are separated by stator blades 141 for channeling the gas flow to the annular nozzle 133 and final jet nozzle 134. The work from the second stage gas turbine fan 132 drives the integral fan blades 111 in a rotational direction opposite to the fan blades 107 of the first gas turbine fan 130. In this manner, the turbofan jet engine is a triple turbofan operable with any thermal source.

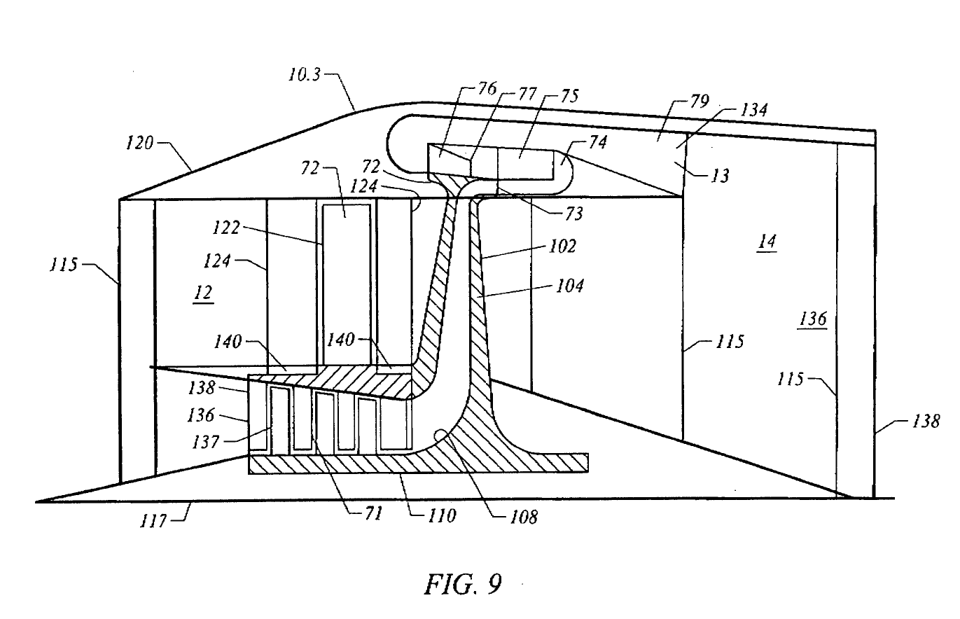

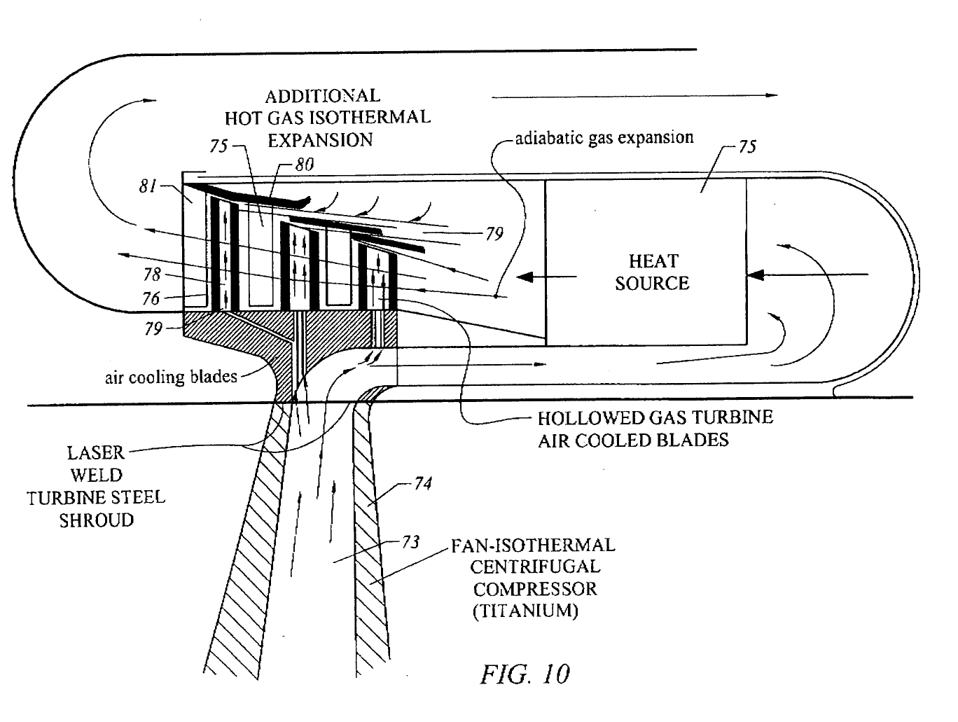

Referring to FIGS. 9 and 10, a turbofan, jet engine 10.3 has a construction similar to the engines 10.1 and 10.2 with a housing 120 supporting a center shaft, 117 on struts 115. The engine 10.3 has an axial compressor 136 with a first series of staged blades 137 rotating counter to the staged blades 138 of the free wheeling fan 139 that rotates on bearings 140, supported by struts 124. The fan blades 122 rotate counter to the turbofan rotor 102 by the ram air on forward motion of the engine 10.3 during flight. The turbofan rotor 102 has a shaft bearing 110 with a hub 108 and a passage through the hollow fan blades 104. The hollow fan blades 104 have a modified blade tip 72 for ejecting the centrifugally compressed air from a side port 73 in the hollow blades 104 into a reverse flow thermal chamber 74 having a heat source 75 that adds thermal energy to the motive gas before isothermic expansion through gas turbine blades 76 in a high temperature blade assembly 77 welded to the ends of the hollow turbofan blades 104 that are preferably a light weight titanium. In the preferred embodiment, the gas turbine blades 76 on the turbofan rotor 102 are hollow with an air passage 78 for passing cold compressed air through the blades for cooling. Also, to improve performance, expansion of gases through the series of turbine blades 76 is in part isothermal by the addition of hot gases at each stage through vent openings 79 in the blade shroud 80 that supports the interspaced stator blades 81. These features allow the heat source 75 to operate at a thermal maximum for the structural composition of the turbine blade assembly 77.

As noted, the heat source 75 may be one of several alternatives, such as a fuel cell, nuclear reactor, or fuel combustor. In the case of a fuel combustor with liquid fuel, added cooling can be obtained by routing some liquid fuel to the air passages 78 of the gas turbine blades 76 as taught in my earlier patent applications. Final expansion in the annular reverse flow thermal chamber ejects hot gases through the annular nozzle 134 for mixing with and heating the cold bypass air passing through the engine for final discharge from the jet nozzle 136 at the end 138 of the engine.

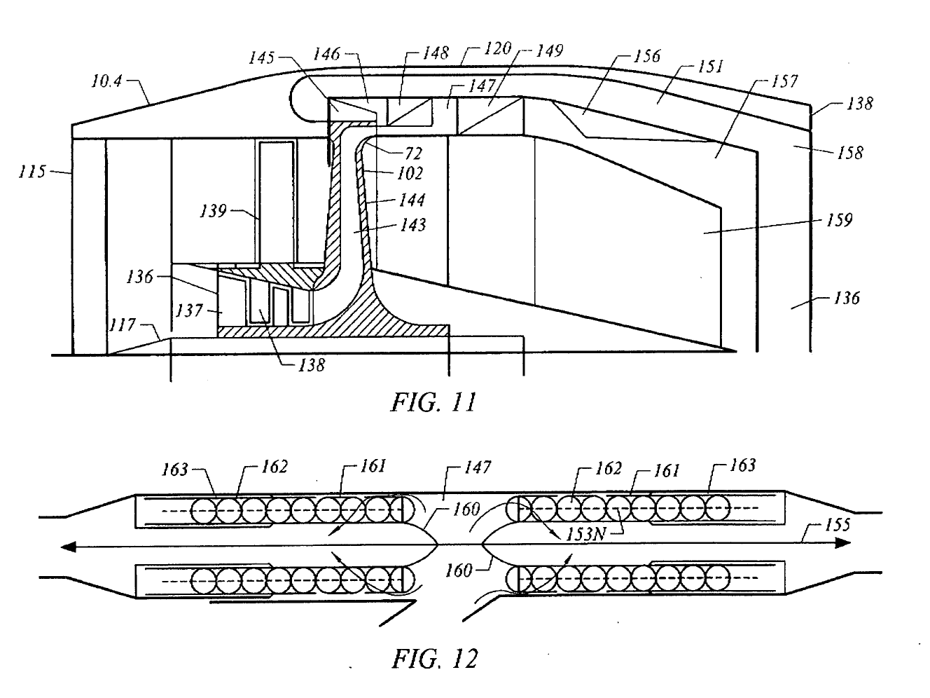

Referring now to FIGS. 11 and 12, a turbofan jet engine 10.4 has a construction similar to the embodiment of FIGS. 9 and 10, and in one preferred embodiment with the nuclear reactor of FIG. 2. The turbofan jet engine 10.4 of FIG. 11 is in part a hybrid rocket with a bifurcated discharge path for thermally heated compressed air. The engine 10.4 has a housing 120 supporting a center shaft 117 on struts 115. An axial compressor 136 has counter rotating staged blades 137, 138 driven respectively by the turbofan rotor 102 and the free wheeling fan 139, as previously described.

In the embodiment of FIG. 11, the turbofan rotor 102 has hollow blades 104 with a modified tip 72 as shown and described with reference to FIGS. 9 and 10. In FIG. 11, a split flow thermal chamber 146 has a common zone 147, where the side ejected compressed air is received between two thermal sources 148 and 149. A reverse flow path through thermal source 148 drives the turbofan rotor 102 by passing through the gas turbine blade assembly 145 as described with reference to FIG. 10. A straight flow path through thermal source 149 as regulated by variable geometry flow control 156 discharges heated gases through rocket nozzle 157 to mix with the adiabatically expanding gases in outer annular passage 151 discharged through jet nozzle 158 for final mix with and heating of bypass air discharged in the core nozzle 159. The final mix is discharged through the combined nozzle 136 at the end 138 of the engine 10.4.

As noted, the two thermal sources 148 and 149 may comprise the same or a combination of alternate thermal sources, such as fuel cells, nuclear reactors or fuel combustors. In one preferred embodiment, where the thermal sources are nuclear reactors, the reactors may be of a simplified form as shown in FIG. 12.

In FIG. 12, the common zone 147 for isothermally compressed air splits, the compressed air flows in opposite directions. A pair of conical baffles 160 directs each flow into an annular perforated retainer 161 for a cluster of nuclear fuel balls 162. The current state-of-the-art in nuclear fuel balls comprises a ball that includes a shell that automatically limits the maximum temperature of the ball rendering a plurality of balls suitable for waterless reactors. Regulation of the thermal output of each cluster is accomplished by a sliding jacket 163 of neutronic absorbent material or thermal insulating material.

By use of a nuclear thermal source, high altitude flight may be maintained vertically, indefinitely.

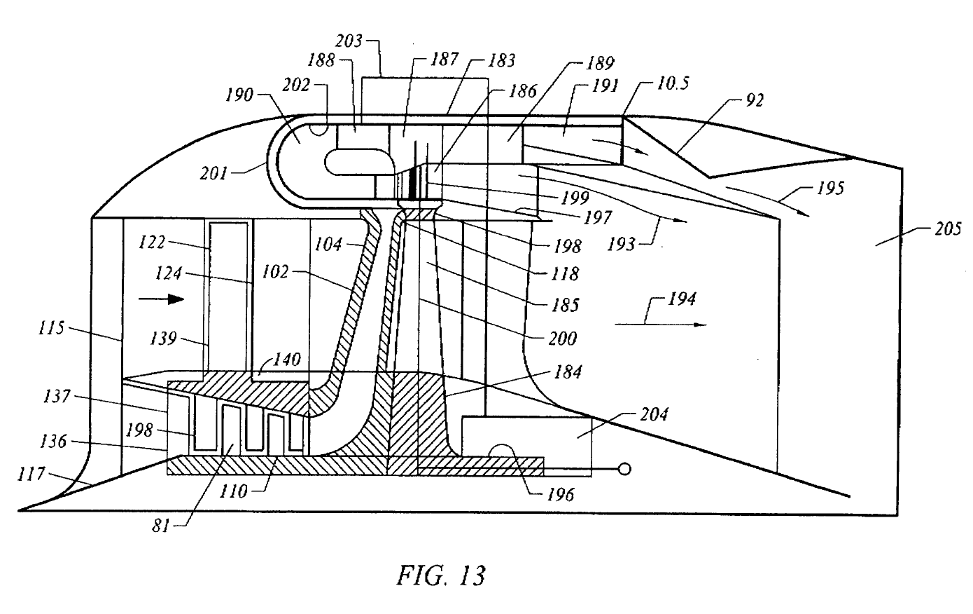

Referring now to FIG. 13, the turbofan jet engine 10.5 has a dual hot gas discharge system similar to FIG. 11 with a separate turbofan rotor 102 and gas turbine rotor 185. This configuration produces a super power density with a potential of more than 100/1 thrust to weight ratio in a compact propulsion system for long range flight.

The turbofan jet engine 10.5 has an outer housing 120 with struts 115 and a center shaft 117 as previously described for the previous embodiments. Again, an aerial compressor 136 with a first series of staged blades 137 rotating counter to the staged blades 138 of the free wheeling fan 139 that rotates on bearings 140 supported by struts 124. The fan blades 122 rotate counter to the hollow fan blades 104 of the turbofan compressor rotor 102.

In the engine 10.5 of FIG. 13, a toroidal combustion chamber 183 has a common zone 187 with a split flow with a first heat source 188 and a second heat source 189. As noted, the heat sources may each be one of several alternatives. The turbofan rotor 102 has a shaft bearing 110 joined to the shaft bearing 196 of a gas turbine rotor 184. The gas turbine rotor 184 has air driving fan blades 185 that rotate in unison with the hollow fan blades 104 of the turbofan compressor rotor 102. The joined assembly is driven by a peripheral turbine blade assembly 186 that is nearly identical to the high temperature blade assembly 77 of FIG. 10, but reversed in direction to discharge heated gases in a flow stream 193 through discharge nozzle 197 directly into the flow stream 194 of the fan driven bypass air.

The tips 118 of the hollow blades 104 are joined to the tips 198 of the fan blades 185 of the gas turbine rotor 184 to pass compressed air from inside the hollow blades 185 to the hollow gas turbine blades 199 as previously described with reference to FIG. 10. This is useful not only to cool the blades 199, but in the case where a fuel combustor is used as the thermal source 188, the air aids in mixing in the chamber 187 with fuel. Fuel in this embodiment is also delivered into the blades 199 by internal supply line 200.

The majority of the compressed air is delivered into a plenum 201 around the thermal chamber 190. The inner wall 202 is perforated in a predefined manner to allow compressed air to bleed into the chamber 190, cooling the chamber walls with the majority of compressed air entering the common zone 187 for supplying the thermal sources 188 and 189.

The reverse flow path from common zone 187 cycles through the heat source 188, which may be a combustor or a fuel cell with an electrical supply 203 from generator 204 connected to bearing 196. The hot gases flow through the blade assembly 186 of the gas turbine rotor 184. The opposite flow path passes compressed air though heat source 189 for expansion in flow path 191 to variable geometry control nozzle 192 for a discharge flow 195 in combined nozzle 205.

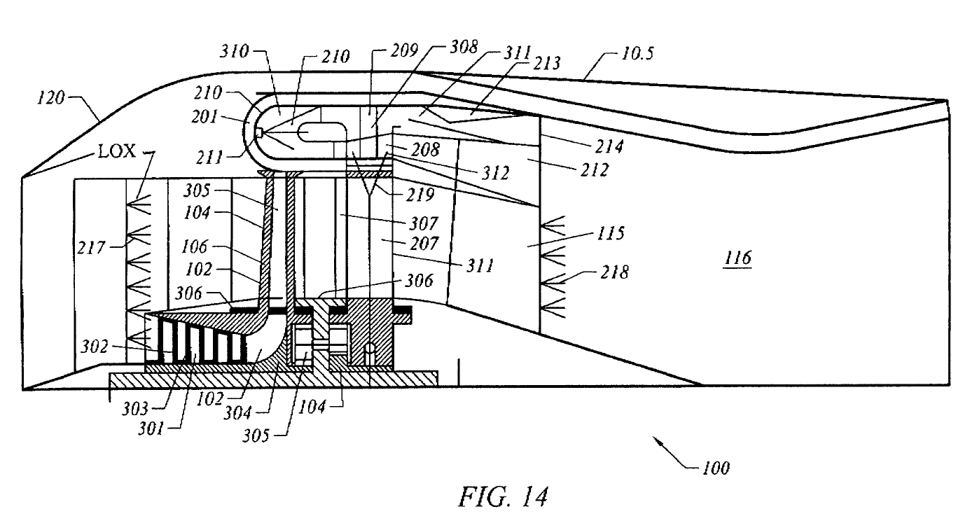

Referring to FIG. 14, the turbofan jet engine 10.5 has a configuration similar to that of FIG. 13 with added features to permit high altitude flight and a separation of the turbofan rotor 102 with hollow blades 104 from the gas turbine rotor 207. In FIG. 14, the axial compressor 301 has a first set of blades 302 fixed to a bearing 304 driven in a first direction by a planetary gear 305 and a second set of blades 303 fixed to the turbofan rotor 102 seated on outer bearings 306 driven in the opposite direction by the planetary gear 305. The bearing support 306 is held in place by a strut 307 connected to the outer housing 120. On the other side of the support 306, the gas turbine rotor 207 is driven by a hot gas blade assembly 208 as previously described with reference to FIGS. 10 and 13. The blade assembly 208 is encompassed by a toroidal combustion chamber 209 with a common zone 308, a reverse flow section 310 and a direct flow section 311 with a variable geometry flow control 213 before a discharge nozzle 214. Isothermally compressed air from the hollow blades 104 is radially ejected from the passage 305 into the plenum 201 around the combustion chamber 209. Fuel is injected by injection nozzle 211 into the chamber 209 and the combustion gases pass through the blade assembly 208 and into the reactive discharge nozzle 212. Additional fuel is injected through fuel passages 219 in the fan blades 311 and blade assembly 208 to evaporate and cool the hot turbine blades 312. Expansion through the blade assembly 208 is isothermal as previously described.

In high altitude flight with limited atmospheric oxygen, the air is supplemented by a liquid oxygen injection through injectors 217. Added fuel can be injected into the bypass flow by fuel injectors 218 for rocket propulsion in addition to the rocket propulsion from nozzle 214 and jet propulsion from nozzle 212.

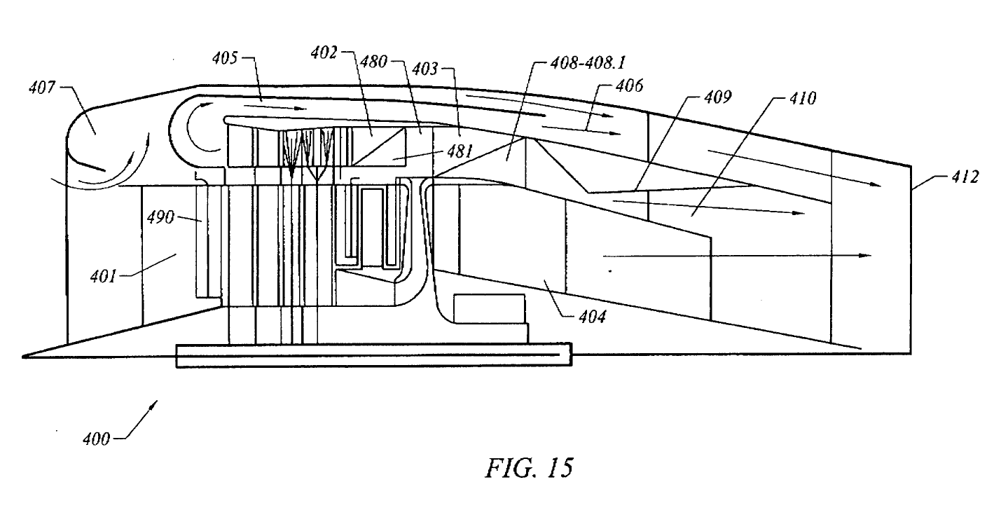

Referring to FIG. 15, the additional embodiment of the engine is indicated generally by the number 400, and basically comprises a central turbofan assembly 401 concentrically encompassed by a turbojet assembly 402 and an air rocket assembly 403. The turbofan assembly 401 produces the jet propulsion effect through the bypass air jet 404.

The turbojet assembly 402 produces the jet propulsion effect through the reverse jet gas reaction passage 405 and the ejector 406 where a mixture of dilution air for reduction of the infrared signature and amplification of the mass of gas flow is received from the air entry plenum 407. The air rocket assembly 403 is provided with a combustion chamber 408 or nuclear reactor 408.1, and a variable geometry nozzle device 409 controlling the gas jet 410.

All three jet gas reaction effects are finally combined and mixed in the gas reactive jet 411 at ejection nozzle 412 with a maximum propulsion efficiency and a minimum exhaust temperature for minimum infrared signature.

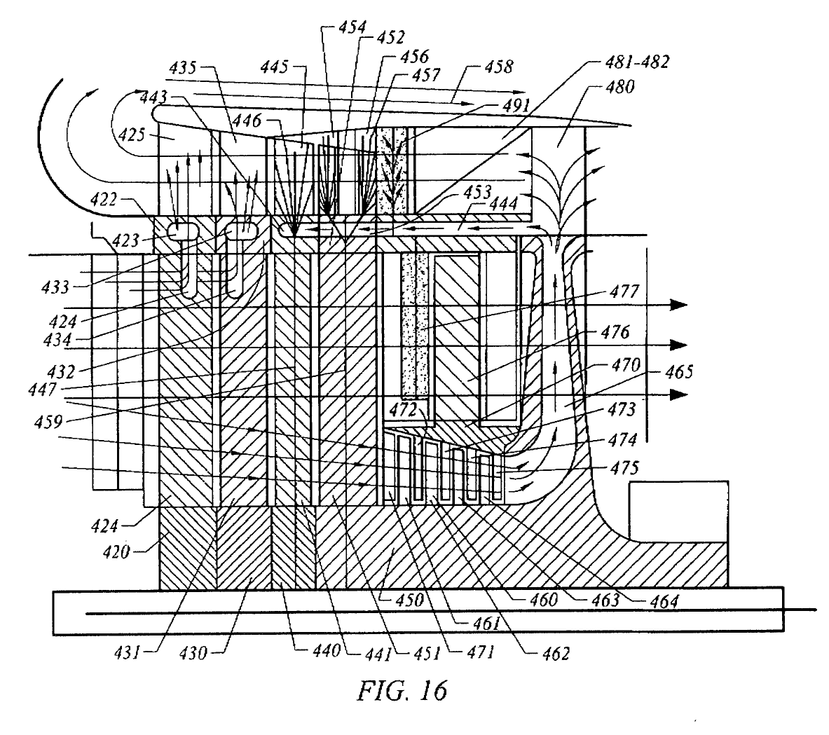

In FIG. 16 there is illustrated an enlarged central composition of the turbo fan assembly 401 and the turbo jet assembly 402. The turbofan assembly 401 includes two counter rotating power gas turbine turbofan rotors 420 and 430. The power gas turbine turbofan rotor 420 includes an assembly of fan blades 421, a ducted peripheral crown 422 that is provided with a circular air collector 423 and air admission windows 424, and hollow gas turbine blades 425.

The counter-rotating power gas turbine turbofan 430 comprises an assembly of fan blades 431 with a ducted peripheral crown 432 that is provided with circular air collectors 433, air admission ports 434, and hollow gas turbine blades 435. The counter-rotating power gas turbine turbofan rotor 440 is an assembly of fan blades 441 with a ducted peripheral crown 442 that is provided with the circular air collectors 443 connected with a common air cooled collector 444, and hollow gas turbine blades 445 that are supplementarily cooled by internally injected fuel 446, supplied through the radial fuel slinger duct 447.

The counter rotating power gas turbine turbofan rotor 450 includes an assembly of fan blades 451 with a ducted peripheral double crown 452 that is provided with the circular air common collector 453 connected with the common air cooled collector 444 and hollow two stages gas turbine blades 455 and 456 that are supplementarily cooled by internally injected fuel 457 and 458 supplied through the radial fuel slinger duct 459. The counter-rotating internal assembly 450 also drives the axial counter-rotating compressor 460, provided with internal axial compressor blades 461, 462, 563, 464 and the centrifugal isothermal compressor 465.

The counter-rotating external assembly 470 is also provided with counter rotating axial compressor blades 471, 472, 473, 474 and 475 and is driven by the air turbine 476 that is controlled by the variable geometry devices 477 located in the strut 478.

The isothermal centrifugal compressor 46 supplies cooled compressed air in a central plenum 480 which is conducting cooled air in the left combustion chamber 481 and/or in the left nuclear reactor 482 and into the common air cooled collector 444.

The triple thermal cycle is provided with the capacity to have isothermal compression and isothermal combustion expansion as described earlier with reference to FIG. 10 and is thereby producing a real Carnot maximum efficient thermal cycle.

A variable geometry intake device 490 in association with variable geometry gas turbine stator blades 491 and the variable geometry air turbine device 477 creates a constant air pressure ratio for constant thermal efficiency from full loads to part loads and minimum specific fuel consumption in all the operational capabilities of the engine in the embodiment.

What is claimed:

1. A turbofan jet engine comprising:
an outer housing;
a center shaft supported in the outer housing by struts;
a core bypass passage through the engine;
an annular, peripheral thermal chamber contained in the outer housing with a thermal source;
an annular expansion chamber communicating with the thermal chamber;
a turbofan compressor rotor with a hub having an entry passage and hollow fan blades with end tips having openings to the thermal chamber wherein air passes from the entry passage through the hollow fan blades and into the thermal chamber;
a gas turbine fan on the center shaft on a common shaft bearing with the turbofan compressor rotor, the gas turbine fan having fan blades in the bypass passage and turbine blades at the ends of the fan blades in the expansion chamber wherein air from the hollow fan blades that is primarily isothermally compressed is heated by the thermal source and expanded in the expansion chamber in a staged partially isothermal expansion by staged addition of the compressed and heated gas; and,
a combined discharge nozzle.

2. The turbofan jet engine of claim 1 wherein the turbofan compressor rotor has a rim at the tips of the fan blades.

3. The turbofan jet engine of claim 1 wherein the hub has air scooping vanes at the entry passage.

4. The turbofan jet engine of claim 1 wherein the heat source is nuclear fuel.

5. The turbofan engine of claim 1 further comprising:
an axial precompressor with a free wheeling fan wherein the entry passage of the hub has staged compressor blades on the hub and staged alternating compressor blades on the free wheeling fan wherein the free wheeling fan has fan blades driven by ram air rotating opposite the hollow fan blades of the turbofan compressor rotor.

6. The turbofan jet engine of claim 5 further comprising a second stage gas turbine fan on the center shaft that rotates opposite the gas turbine fan connected to the turbofan compressor rotor wherein the second stage gas turbine fan has fan blades in the bypass passage and turbine blades at the end of the fan blades in the expansion chamber with the fan blades being driven by the turbine blades.

7. The turbofan jet engine of claim 5 wherein the thermal source is a nuclear fuel.

8. A turbofan jet engine comprising:
an outer housing;
a center shaft supported in the outer housing by struts;
a core bypass passage through the engine;
an annular, peripheral thermal chamber contained in the outer housing, the chamber having a thermal source;
an annular expansion chamber communicating with the thermal chamber;
a turbofan compressor rotor with a hub having an entry passage and hollow fan blades wherein the fan blades have a tip with a side port for ejecting centrifugally compressed air to the thermal chamber wherein the tip of the fan blades have staged turbine blades in the expansion chamber and wherein the thermal chamber has a reverse flow through the thermal source and to the expansion chamber;
an axial precompressor with a free wheeling fan wherein the entry passage of the hub has staged compressor blades on the hub and staged alternating compressor blades on the free wheeling fan wherein the free wheeling fan has fan blades driven by ram air rotating opposite the hollow fan blades of the turbofan compressor rotor wherein air from the hollow fan blades that is primarily isothermally compressed is heated by the thermal source and expanded in the expansion chamber in a staged partially isothermal expansion; and,
a combined discharge nozzle.

9. The turbofan jet engine of claim 8 wherein the expansion chamber has a reverse flow to the common discharge nozzle.

10. The turbofan jet engine of claim 8 wherein the staged turbine blades have air cooling passages communicating with the passage in the hollow fan blades.

11. The turbofan jet engine of claim 10 wherein the annular expansion chamber around the staged turbine blades has a blade shroud with stator blades interspaced with the turbine blades wherein the shroud has vent openings at each of the stages of the turbine blades for passage of heated gases from the thermal chamber.

12. The turbofan jet engine of claim 8 wherein the thermal chamber has a split flow with a common zone where the ejected compressed air from the side port of the fan blade tip enters with the reverse flow through the thermal source and expansion chamber with the staged turbine blades as one flow path and a direct flow through a second thermal source with a direct passage with flow controls as another path to a rocket nozzle located between an outer jet nozzle and inner core nozzle for final mix in the combined discharge nozzle.

13. The turbofan jet engine of claim 12 wherein at least one of the thermal sources is a nuclear reactor.

14. The turbofan jet engine of claim 1 wherein the thermal chamber has a split flow with a common zone wherein the gas turbine fan and turbofan compressor rotor are connected with the ejected compressed air flowing into a plenum and to the common zone with a first reverse flow through the thermal source and through the turbine blades in the expansion chamber and a second direct flow through a second thermal source to a variable geometry control nozzle for discharge in the combined discharge nozzle.

15. The turbofan jet engine of claim 14 wherein the fan blades and turbine blades of the gas turbine fan have fuel passages for discharge of fuel from the ends of the turbine blades into the common zone of the thermal chamber.

16. The turbofan jet engine of claim 14 wherein the common shaft bearing connecting the turbofan compressor rotor and the gas turbine fan is split and has a gear mechanism connecting the turbofan compressor rotor and gas turbine fan for counter-rotation of the turbofan compressor rotor and gas turbine fan.

17. The turbofan jet engine of claim 16 wherein liquid oxygen nozzles are included in the core bypass passage and entry passage to the compressor for adding oxygen.

18. A turbofan jet engine comprising:
an outer housing having an air intake and a combined ejection nozzle;
a center shaft supported in the outer housing having struts connecting the outer housing and center shaft;
a core bypass passage through the engine from the air intake to the combined ejection nozzle;
an annular, peripheral thermal chamber contained in the outer housing, the chamber having at least one thermal source;
a central turbofan assembly proximate the air intake having multiple stages of fan blades with a ducted crown at the tips of the blades with air collectors and hollow turbine blades projecting from the crown wherein ram air collected by the ducted crown passes through the hollow blades; and,
a turbofan compressor rotor having a compressed air intake, hollow fan blades having blade tips with openings wherein air is primarily isothermally compressed and is in part directed to a passage to the ducted crown of select stages of the turbofan blades in part directed to a thermal source and expansion chamber for partially isothermal expansion and in part directed to the combined ejection nozzle.

19. The turbofan jet engine of claim 18 further comprising:
an axial compressor with a free wheeling fan wherein the turbofan compressor rotor has a hub with staged precompressor blades and the free wheeling fan has a counter-rotating external hub assembly with inwardly directed staged precompressor blades of the turbofan compressor rotor.

20. The turbofan jet engine of claim 18 wherein the central turbofan assembly includes added stages of turbofan blades with blade tips and a ducted crown and turbine blades wherein the added stages of turbofan blades have fuel passages to the turbine blades for ejection into a peripheral combustion chamber that communicates with the expansion chamber with the multiple stages of turbine blades.
